(19) United States
(12) Patent Application Publication
(10) Pub. No.: US 2023/0228211 A1
(43) Pub. Date: Jul. 20, 2023

(54) HYBRID ELECTRIC VEHICLE

(71) Applicant: TOYOTA JIDOSHA KABUSHIKI KAISHA, Aichi-ken (JP)

(72) Inventors: Koji ICHIKAWA, Aichi-ken (JP); Noriaki KUMAGAI, Toyota-shi (JP); Takahiro YOSHIDA, Nagoya-shi (JP)

(21) Appl. No.: 18/071,633

(22) Filed: Nov. 30, 2022

(30) Foreign Application Priority Data
Jan. 17, 2022 (JP) 2022-005029

(51) Int. Cl. F01P 3/20; F01P 7/16

(52) U.S. Cl. CPC F01P 3/20; F01P 7/165; F01P 2060/02; F01P 2031/36; F01P 2050/24

(57) ABSTRACT

A hybrid electric vehicle includes: an engine including a turbocharger and an intercooler that cools intake air; a motor; an inverter for driving the motor; a cooling device for cooling the inverter and the intake air by circulating a cooling medium by a circulation pump in a circulation path including a cooling flow path for cooling the inverter and a cooling flow path for the intercooler as a flow path; and a control device for controlling the cooling device. The control device permits forced drive of the circulation pump from an outside when predetermined conditions including a condition that a vehicle speed is equal to or lower than a predetermined vehicle speed and a condition that a vehicle system is turned off are satisfied.

### CROSS-REFERENCE TO RELATED APPLICATION

This application claims priority to Japanese Patent Application No. 2022-005029 filed on Jan. 17, 2022, incorporated herein by reference in its entirety.

### BACKGROUND

### 1. Technical Field

The present disclosure relates to a hybrid electric vehicle, and more particularly, to a hybrid electric vehicle including a cooling device in which an intercooler mounted on an intake system of an engine and an inverter driving a motor are incorporated into a circulation path.

### 2. Description of Related Art

Conventionally, as this type of hybrid electric vehicle, there has been proposed a hybrid electric vehicle including a cooling device that circulates coolant by a water pump in a circulation path including an inverter driving a traveling motor, an intercooler, and a radiator (see, for example, Japanese Unexamined Patent Application Publication No. 2013-79614 (JP 2013-79614 A)). In this hybrid electric vehicle, the circulation path of the cooling device is provided separately from the circulation path where the coolant that cools the engine circulates to simplify the circuit configuration and reduce the size of the device.

### SUMMARY

Generally, in hybrid electric vehicles, when the vehicle undergoes maintenance such as a failure diagnosis, a water pump is forcibly driven by signals input from an external tool while the vehicle is stopped. In a cooling device that includes an inverter, an intercooler, and a radiator in a circulation path, it is necessary to drive the water pump when a cooling request is made based on the temperature of the inverter even when the vehicle is stopped. When such a cooling request and forced drive by signals input from the external tool are performed at the same time, if the cooling request is prioritized, vehicle maintenance (failure diagnosis, etc.) is hindered, and if the forced drive is prioritized, the cooling of the inverter is hindered.

The main objective of the hybrid electric vehicle of the present disclosure is to more appropriately perform forced drive of a circulation pump in the cooling device from the outside.

The hybrid electric vehicle of the present disclosure adopts the following means in order to achieve the main objective described above.

A hybrid electric vehicle of the present disclosure includes: an engine including a turbocharger and an intercooler for cooling intake air; a motor; an inverter for driving the motor; a cooling device for cooling the inverter and the intake air by circulating a cooling medium by a circulation pump in a circulation path including a cooling flow path for cooling the inverter and a cooling flow path for the intercooler as a flow path; and a control device for controlling at least the cooling device. The control device permits forced drive of the circulation pump from an outside when predetermined conditions including a condition that a vehicle speed is equal to or lower than a predetermined vehicle speed and a condition that a vehicle system is turned off are satisfied.

The hybrid electric vehicle of the present disclosure includes: an engine including a turbocharger and an intercooler for cooling intake air; a motor; an inverter for driving the motor; a cooling device for cooling the inverter and the intake air by circulating a cooling medium by a circulation pump in a circulation path including a cooling flow path for cooling the inverter and a cooling flow path for the intercooler as a flow path; and a control device for controlling at least the cooling device. The control device permits forced drive of the circulation pump from an outside when predetermined conditions including a condition that a vehicle speed is equal to or lower than a predetermined vehicle speed and a condition that a vehicle system is turned off are satisfied. Thereby, when the predetermined conditions are not satisfied, the circulation pump is driven by the cooling request of the intake air or inverter, and the forced drive from the outside is not performed, so that the forced drive of the circulation pump in the cooling device from the outside can be performed more appropriately.

In the hybrid electric vehicle of the present disclosure, when a required drive instruction value of the circulation pump and a forced drive instruction value for the forced drive of the circulation pump from the outside both exist, a larger instruction value of the required drive instruction value and the forced drive instruction value may be used to drive the circulation pump. That is, when the required drive instruction value is larger than the forced drive instruction value, the required drive instruction value is used to drive the circulation pump, and when the required drive instruction value is smaller than the forced drive instruction value, the forced drive instruction value is used to drive the circulation pump. Thus, overheating of the inverter and the like can be suppressed.

In the hybrid electric vehicle of the present disclosure, the control device may not permit the forced drive of the circulation pump from the outside when an abnormality has occurred in the circulation pump. This is because, when some abnormality has occurred in the circulation pump, good vehicle maintenance (failure diagnosis) cannot be performed even if the circulation pump is forcibly driven.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a schematic configuration of a hybrid electric vehicle 20 as an embodiment of the present disclosure;

FIG. 2 is a flowchart showing an example of a water pump drive process executed by an engine electronic control unit (ECU) 24; and

FIG. 3 is a flowchart showing an example of a water pump forced drive permission determination process executed by the engine ECU 24.

### DETAILED DESCRIPTION OF EMBODIMENTS

Next, modes for carrying out the disclosure will be described using an embodiment.

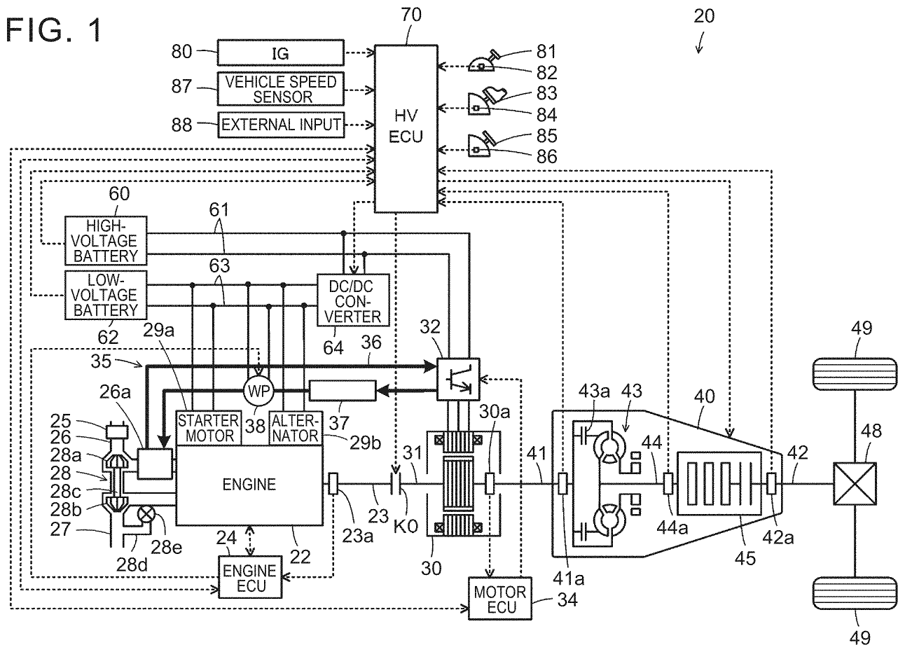

FIG. 1 is a configuration diagram showing a schematic configuration of a hybrid electric vehicle 20 as an embodiment of the present disclosure. The hybrid electric vehicle 20 of the embodiment includes an engine 22, a motor 30, an inverter 32, a cooling device 35, a clutch K0, an automatic transmission device 40, a high-voltage battery 60, a low-voltage battery 62, a direct current-to-direct current (DC/DC) converter 64, and a hybrid electronic control unit (hereinafter referred to as “HV ECU”) 70, as shown in FIG. 1.

The engine 22 is configured as an internal combustion engine that outputs power using fuel such as gasoline or light oil from a fuel tank. A crankshaft 23 of the engine 22 is connected to a rotation shaft 31 (rotor) of the motor 30 via the clutch K0. The engine 22 includes a turbo-supercharger (so called turbocharger) 28 that supercharges the engine 22 using exhaust energy.

The turbocharger 28 includes a compressor 28a disposed in an intake pipe 26 connected to an air cleaner 25, a turbine 28b disposed in an exhaust pipe 27, a connecting shaft 28c connecting the compressor 28a and the turbine 28b, a bypass pipe 28d attached to the exhaust pipe 27 to bypass the turbine 28b, and a waste gate valve 28e provided in the bypass pipe 28d. In the turbocharger 28, by adjusting the opening degree of the waste gate valve 28e, the distribution ratio between the amount of exhaust gas flowing through the bypass pipe 28d and the amount of exhaust gas flowing through the turbine 28b is adjusted (the smaller the opening degree of the waste gate valve 28e is, the less the adjusted amount of exhaust gas that flows through the bypass pipe 28d and the more the adjusted amount of exhaust gas that flows through the turbine 28b), the rotational driving force of the turbine 28b is adjusted, the amount of air compressed by the compressor 28a is adjusted, and the boost pressure (intake pressure) of the engine 22 is adjusted. The engine 22 can operate in the same way as a naturally aspirated engine without a turbocharger 28 when the waste gate valve 28e is fully open. Further, an intercooler 26a for cooling the intake air is installed downstream of the compressor 28a of the intake pipe 26.

The operation of the engine 22 is controlled by an engine electronic control unit (hereinafter referred to as the “engine ECU”) 24. Although not shown, the engine ECU 24 includes a microcomputer having a central processing unit (CPU), a read-only memory (ROM), a random access memory (RAM), a flash memory, an input/output port, and a communication port. Signals from various sensors necessary for controlling the operation of the engine 22 are input to the engine ECU 24 via an input port. The signals include, for example, a crank angle θcr from a crank position sensor that detects the rotational position of the crankshaft 23 of the engine 22, and an intake air amount Qa from an air flow meter disposed on the upstream side of the compressor 28a of the intake pipe 26. Various control signals for controlling the operation of the engine 22 are output from the engine ECU 24 via an output port. The control signals include, for example, control signals to throttle valves, fuel injection valves, spark plugs, the waste gate valve 28e, and the like, and drive signals to a water pump 38 described later. The engine ECU 24 is connected to the HV ECU 70 via a communication port. The engine ECU 24 calculates the rotational speed Ne of the engine 22 based on the crank angle θcr of the engine 22 from the crank position sensor, or the load factor (ratio of the volume of air actually taken in at one cycle to the stroke volume per cycle of the engine 22) KL based on the intake air amount Qa from the air flow meter and the rotational speed Ne of the engine 22.

A starter motor 29a for cranking the engine 22 and an alternator 29b for generating electric power using power from the engine 22 are connected to the crankshaft 23 of the engine 22. The starter motor 29a and the alternator 29b are connected to low-voltage side power lines 63 together with the low-voltage battery 62 and are controlled by the HV

ECU 70.

The motor 30 is configured as a synchronous generator motor, and has a rotor in which a permanent magnet is embedded in a rotor core, and a stator in which a three-phase coil is wound around a stator core. A rotation shaft 31 to which the rotor of the motor 30 is fixed is connected to the crankshaft 23 of the engine 22 via the clutch K0 and is connected to an input shaft 41 of an automatic transmission 45. The inverter 32 is used to drive the motor 30 and is connected to high-voltage side power lines 61. The motor 30 is rotationally driven when a motor electronic control unit (hereinafter referred to as “motor ECU”) 34 performs switching control on a plurality of switching elements of the inverter 32.

Although not shown, the motor ECU 34 includes a microcomputer having a CPU, a ROM, a RAM, a flash memory, an input/output port, and a communication port. Signals from various sensors are input to the motor ECU 34 via an input port. Examples of the signals input to the motor ECU 34 may include a rotational position θm from a rotational position sensor 30a for detecting the rotational position of the rotor (rotation shaft 31) of the motor 30, and a phase current Iu, Iv from the current sensor for detecting the phase current of each phase of the motor 30. Control signals to the inverter 32 and the like are output from the motor ECU 34 via an output port. The motor ECU 34 is connected to the HV ECU 70 via a communication port. The motor ECU 34 calculates the rotational speed Nm of the motor 30 based on the rotational position θm of the rotor (rotation shaft 31) of the motor 30 from the rotational position sensor 30a.

The cooling device 35 includes a circulation path 36 that includes a cooling flow path of the intercooler 26a and a cooling flow path of the inverter 32 as a flow path, a radiator 37 incorporated into the circulation path 36, and the water pump 38 that circulates coolant in the circulation path 36, to cool down the intake air and the inverter 32. The water pump 38 is connected to the low-voltage side power lines 63 and is driven and controlled by the engine ECU 24.

The clutch K0 is configured, for example, as a hydraulic driven friction clutch and is controlled by the HV ECU 70 to connect and disconnect the crankshaft 23 of the engine 22 to and from the rotation shaft 31 of the motor 30. The clutch K0 is controlled by the HV ECU 70.

The automatic transmission device 40 includes a torque converter 43 and an automatic transmission 45 having six gears. The torque converter 43 is configured as a general fluid transmission device, and transmits the power from the input shaft 41 connected to the rotation shaft 31 of the motor 30 to a transmission input shaft 44 that is an input shaft of the automatic transmission 45 by amplifying the torque, or transmits the power as it is without amplifying the torque. The automatic transmission 45 includes the transmission input shaft 44, an output shaft 42 connected to drive wheels 49 via a differential gear 48, a plurality of planetary gears, and a plurality of hydraulic driven frictional engagement elements (clutches, brakes). Each of the frictional engagement elements has a hydraulic servo comprising a piston, a plurality of frictional engagement plates (friction plates and separator plates), an oil chamber to which hydraulic fluid is supplied, and the like. The automatic transmission 45 establishes a forward gear or a rearward gear from first gear to sixth gear by engaging and disengaging the frictional engagement elements, and thereby transmits power between the transmission input shaft 44 and the output shaft 42. Hydraulic pressure of hydraulic oil from a mechanical oil pump or an electric oil pump is regulated and supplied to the clutch K0 or the automatic transmission 45 by a hydraulic control device (not shown). The hydraulic control device includes a valve body provided with a plurality of oil passages, a plurality of regulator valves, a plurality of linear solenoid valves, and the like. The hydraulic control device is controlled by the HV ECU 70.

The high-voltage battery 60 is configured as, for example, a lithium ion secondary battery or a nickel hydrogen secondary battery having a rated voltage of about several hundred V, and is connected to the high-voltage side power lines 61 together with the inverter 32. The low-voltage battery 62 is configured as, for example, a lead storage battery having a rated voltage of about 12 V or 14 V, and is connected to the low-voltage side power lines 63 together with the starter motor 29a and the alternator 29b. The DC/DC converter 64 is connected to the high-voltage side power lines 61 and the low-voltage side power lines 63. The DC/DC converter 64 supplies electric power from the high-voltage side power lines 61 to the low-voltage side power lines 63 with a voltage step-down.

Although not shown, the HV ECU 70 includes a microcomputer having a CPU, a ROM, a RAM, a flash memory, an input/output port, and a communication port. Signals from various sensors are input to the HV ECU 70 via an input port. Examples of the signals input to the HV ECU 70 may include a rotational speed Nin from a rotational speed sensor 41a attached to the input shaft 41 of the automatic transmission device 40, a rotational speed Nmi from a rotational speed sensor 44a attached to the transmission input shaft 44 of the automatic transmission device 40, and a rotational speed Nout from a rotational speed sensor 42a attached to the output shaft 42 of the automatic transmission device 40. Examples of the signals input to the HV ECU 70 may also include a voltage Vbh of the high-voltage battery 60 from a voltage sensor attached between terminals of the high-voltage battery 60, a current Ibh of the high-voltage battery 60 from a current sensor attached to an output terminal of the high-voltage battery 60, and a voltage Vbl from a voltage sensor attached between terminals of the low-voltage battery 62. Examples of the signals input to the HV ECU 70 may also include an ignition signal from an ignition switch 80, a shift position SP from a shift position sensor 82 for detecting the operation position of a shift lever 81, an accelerator operation amount Acc from an accelerator pedal position sensor 84 for detecting the depression amount of an accelerator pedal 83, a brake pedal position BP from a brake pedal position sensor 86 for detecting the depression amount of a brake pedal 85, and a vehicle speed V from a vehicle speed sensor 87. Examples of the signals input to the HV

ECU 70 may also include an IC temperature Tic from a temperature sensor (not shown) mounted on the intercooler 26a and an inverter temperature Tiny from a temperature sensor (not shown) mounted on the inverter 32. Furthermore, examples of the signals input to the HV ECU 70 may also include a forced drive instruction value Dtf from an external input 88 for forcibly driving the water pump 38 of the cooling device 35.

Various control signals are output from the HV ECU 70 via an output port. Examples of the signals output from the HV ECU 70 may include a control signal to the starter motor 29a and a control signal to the alternator 29b. Examples of the signals output from the HV ECU 70 may also include a control signal to the clutch K0 and the automatic transmission device 40 (hydraulic control device), and a control signal to the DC/DC converter 64. The HV ECU 70 is connected to the engine ECU 24 and the motor ECU 34 via a communication port. The HV ECU 70 calculates a rotational speed ratio Gt of the automatic transmission device 40 by dividing the rotational speed Nin of the input shaft 41 of the automatic transmission device 40 from the rotational speed sensor 41a by the rotational speed Nout of the output shaft 42 of the automatic transmission device 40 from the rotational speed sensor 42a.

In the hybrid electric vehicle 20 of the embodiment configured as described above, the engine 22, the clutch K0, the motor 30, and the automatic transmission device 40 are controlled so that the hybrid electric vehicle 20 travels in a hybrid traveling mode (HV traveling mode) or an electric traveling mode (EV traveling mode) by cooperative control between the HV ECU 70, the engine ECU 24, and the motor ECU 34. Here, the HV traveling mode is a mode in which the clutch K0 is engaged and traveling is performed using the power of the engine 22, and the EV traveling mode is a mode in which the clutch K0 is released and traveling is performed without using the power of the engine 22.

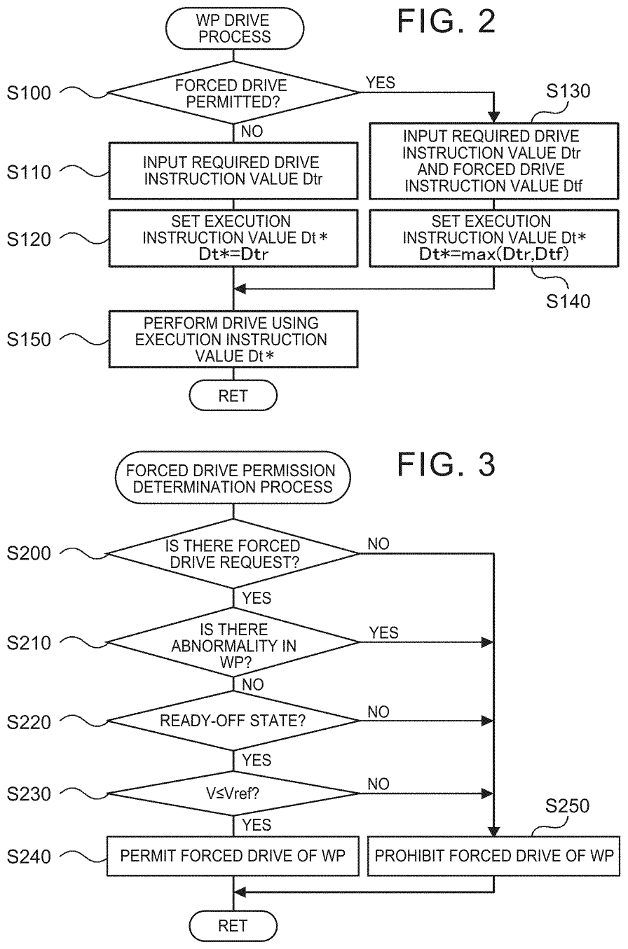

Next, the operation of the hybrid electric vehicle 20 of the embodiment thus configured, in particular, the operation of the drive process of the water pump 38 and the operation of the permission determination process of the forced drive of the water pump 38 from the external input 88 will be described. FIG. 2 is a flowchart showing an example of the drive process of the water pump 38 executed by the engine ECU 24, and FIG. 3 is a flowchart showing an example of a forced drive permission determination process of the water pump 38 executed by the engine ECU 24. The drive process of the water pump 38 in FIG. 2 and the forced drive permission determination process of the water pump 38 in FIG. 3 are repeatedly executed every predetermined time that is each determined in advance.

When the drive process of the water pump 38 in FIG. 2 is executed, the engine ECU 24 first determines whether the forced drive of the water pump 38 based on the forced drive instruction value Dtf from the external input 88 is permitted (step S100). Since the determination of whether the forced drive of the water pump 38 is permitted is performed through the permission determination of the forced drive of the water pump 38 by the forced drive permission determination process in FIG. 3, the determination can be made using the result in FIG. 3. The forced drive permission determination process in FIG. 3 will be described later.

When it is determined in step S100 that the forced drive of the water pump 38 is not permitted, the required drive instruction value Dtr set based on the temperature of the intercooler 26a (IC temperature) Tic and the temperature of the inverter 32 (inverter temperature) Tiny are input (step S110), and the input required drive instruction value Dtr is set as the execution instruction value Dt* (step S120). Then, the water pump 38 is driven and controlled using the execution instruction value Dt* (step S150), and the process is terminated. Here, as the required drive instruction value Dtr, a duty for performing duty drive on the motor (not shown) in the water pump 38 can be used.

When it is determined in step S100 that the forced drive of the water pump 38 is permitted, the required drive instruction value Dtr and the forced drive instruction value Dtf from the external input 88 are input (step S130), and the larger of the required drive instruction value Dtr and the forced drive instruction value Dtf that have been input is set as the execution instruction value Dt* (step S140). Then, the water pump 38 is driven and controlled using the execution instruction value Dt* (step S150), and the process is terminated. Here, also as the forced drive instruction value Dtf, a duty for performing duty drive on the motor (not shown) in the water pump 38 can be used.

When the forced drive permission determination process of the water pump 38 in FIG. 3 is executed, the engine ECU 24 determines whether there is a forced drive request of the water pump 38 (step S200). The determination of whether there is a forced drive request of the water pump 38 can be performed based on whether the forced drive instruction value Dtf is input from the external input 88. That is, when the forced drive instruction value Dtf is input from the external input 88, it is determined that there is a forced drive request of the water pump 38, and when the forced drive instruction value Dtf is not input from the external input 88, it is determined that there is no forced drive request of the water pump 38. When it is determined that there is no forced drive request of the water pump 38, since it is not necessary to permit the forced drive of the water pump 38, the forced drive of the water pump 38 is prohibited (step S250), and the process is terminated.

When it is determined in step S200 that there is a forced drive request of the water pump 38, it is determined whether conditions for permitting the forced drive of the water pump 38 are satisfied (step S210 to step S230). Examples of the conditions for permitting the forced drive of the water pump 38 may include a condition that there is no abnormality in the water pump 38 (step S210), a condition that a vehicle system is in a ready-off state (system stop state) (step S220), and a condition that the vehicle speed V is equal to or lower than a threshold value Vref (step S230). In the embodiment, when all these conditions are satisfied, it is determined that the conditions for permitting the forced drive of the water pump 38 are satisfied. Examples of the condition that there is no abnormality in the water pump 38 may include that the water pump 38 is not in a lock-fail state in particular. The condition that the vehicle system is in the ready-off state (system stop state) is based on the fact that the vehicle system is preferably in the ready-off state since the forced drive of the water pump 38 from the external input 88 is performed by a dealer or the like of the vehicle to check the performance of the water pump 38 or the like. The condition that the vehicle speed V is equal to or lower than the threshold value Vref specifically intends that the vehicle is at a standstill. Thus, a small value is used as the threshold value Vref, such as 2 km/h or 3 km/h.

When it is determined in step S210 to step S230 that the conditions for permitting the forced drive of the water pump 38 are not satisfied, the forced drive of the water pump 38 is prohibited (step S250), and the process is terminated. When it is determined in step S210 to step S230 that the conditions for permitting the forced drive of the water pump 38 are satisfied, the forced drive of the water pump 38 is permitted (step S240), and the process is terminated.

In the hybrid electric vehicle 20 of the embodiment described above, the forced drive of the water pump 38 from the external input 88 is permitted when the conditions for permitting the forced drive of the water pump 38 are satisfied, such as the condition that there is no abnormality in the water pump 38, the condition that the vehicle system is in the ready-off state (system stop state), and the condition that the vehicle speed V is equal to or lower than the threshold value Vref (a condition that the vehicle is stopped). Accordingly, the forced drive of the water pump 38 from the external input 88 can be performed more appropriately.

In the hybrid electric vehicle 20 of the embodiment, when the required drive instruction value Dtr and the forced drive instruction value Dtf from the external input 88 both exist while the forced drive of the water pump 38 is permitted, the larger of the required drive instruction value Dtr and the forced drive instruction value Dtf is set as the execution instruction value Dt* to drive and control the water pump 38. Thus, overheating of the intercooler 26a and the inverter 32 can be suppressed.

The hybrid electric vehicle 20 of the embodiment is provided with the automatic transmission 45 having six gears. However, the hybrid electric vehicle 20 may be provided with an automatic transmission having four gears, five gears, eight gears, or the like.

The hybrid electric vehicle 20 of the embodiment is provided with the engine ECU 24, the motor ECU 34, and the HV ECU 70. However, at least two of these may be configured integrally.

In the embodiment, the present disclosure was applied to the hybrid electric vehicle 20 including the engine 22 including the turbocharger 28 and the intercooler 26a for cooling the intake air, the motor 30, the inverter 32, the cooling device 35 for cooling the inverter 32 and the intake air, the clutch K0, and the automatic transmission device 40.

However, as long as the configuration includes an engine including a turbocharger and an intercooler for cooling the intake air, a motor, an inverter, and a cooling device for cooling the inverter and the intake air, the present disclosure can be applied to a hybrid electric vehicle of any configuration.

The correspondence between the main elements of the embodiment and the main elements of the disclosure described in the SUMMARY will be described. In the embodiment, the turbocharger 28 corresponds to a “turbocharger”, the intercooler 26a corresponds to an “intercooler”, the engine 22 corresponds to an “engine”, the motor 30 corresponds to a “motor”, the inverter 32 corresponds to an “inverter”, the cooling device 35 corresponds to a “cooling device”, and the HV ECU 70, the engine ECU 24, and the motor ECU 34 correspond to a “control device”.

As for the correspondence between the main elements of the embodiment and the main elements of the disclosure described in the SUMMARY, since the embodiment is an example for specifically describing a mode for carrying out the disclosure described in the SUMMARY, the embodiment does not limit the elements of the disclosure described in the SUMMARY. In other words, the interpretation of the disclosure described in the SUMMARY should be performed based on the description in the SUMMARY, and the embodiment is merely a specific example of the disclosure described in the SUMMARY.

Although the modes for carrying out the disclosure have been described above with the embodiment, the disclosure is not limited to the embodiment, and may be embodied in various modes without departing from the scope of the disclosure.

The present disclosure is applicable to the manufacturing industry of a hybrid electric vehicle and the like.

What is claimed is:

1. A hybrid electric vehicle comprising:
an engine including a turbocharger and an intercooler for cooling intake air;
a motor;
an inverter for driving the motor;
a cooling device for cooling the inverter and the intake air by circulating a cooling medium by a circulation pump in a circulation path including a cooling flow path for cooling the inverter and a cooling flow path for the intercooler as a flow path; and
a control device for controlling at least the cooling device, wherein the control device permits forced drive of the circulation pump from an outside when predetermined conditions including a condition that a vehicle speed is equal to or lower than a predetermined vehicle speed and a condition that a vehicle system is turned off are satisfied.

2. The hybrid electric vehicle according to claim 1, when a required drive instruction value of the circulation pump and a forced drive instruction value for the forced drive of the circulation pump from the outside both exist, a larger instruction value of the required drive instruction value and the forced drive instruction value is used to drive the circulation pump.

3. The hybrid electric vehicle according to claim 1, wherein the control device does not permit the forced drive of the circulation pump from the outside when an abnormality has occurred in the circulation pump.
